(19) United States
(12) Patent Application Publication
(10) Pub. No.: US 2006/0142060 A1
(43) Pub. Date: Jun. 29, 2006

(54) Transmitter-receiver earphone set having a foldable receiver unit

(75) Inventor: Wen-Wei Sun, Taipei Hsien (TW)

Correspondence Address: BACON & THOMAS, PLLC, 625 SLATERS LANE, FOURTH FLOOR, ALEXANDRIA, VA, 22314, US

(73) Assignee: WANG WANG DAH ENTERPRISE CO., LTD., TAIPEI HSIEN (TW)

(21) Appl. No.: 11/022,830

(22) Filed: Dec. 28, 2004

(51) Int. Cl. H04B 7/00

(52) U.S. Cl. 455/557

(57) ABSTRACT

The present invention is to provide a folding earphone comprising a narrow elongated hollow body having a protruding transmitter unit at one end thereof. The transmitter unit has a speaker and a cable extending from the speaker toward the inside thereof for connecting to an external electronic apparatus, a narrow elongated groove extending outwards from a bottom side to a pivot end thereof. A receiver unit receivable in the narrow elongated groove has a free end mounted with a microphone and a fixed end pivotally coupled to the pivot end of the body, enabling the receiver unit to be turned relative to the body between a non-operative position where the free end is received inside the narrow elongated groove and an operative position where the free end is moved out of the narrow elongated groove.

### BACKGROUND OF THE INVENTION

1. Field of the Invention

The present invention relates generally to an earphone, more particularly to a folding earphone set comprising a narrow elongated hollow body for receiving a receiver unit in a narrow elongated groove provided therein, enabling a user to extend the receiver unit out of the body of the earphone set and to a position close to the user's mouth when in use and receive the receiver unit in the body of the earphone set when not in use.

2. Description of the Related Art

Following the step of cyber era, circulation of messages become fast. Because people's demand for message the circulating flow of message among people are heavy, various mobile electronic apparatus are developed to meet the requirement. These electronic apparatus include mobile music players, MP3 players, cell phones, and mobile sound reproducing apparatus have been intensively used by people in different fields and have become requisite means in many people's daily life. These apparatus are indeed convenient and efficient communication tools.

The use of the aforesaid mobile electronic apparatus to receive sound may be different subject to the environments. For example, when using a cell phone during driving, the user may have to control the steering wheel with one hand and to hold the cell phone with the other hand. It is dangerous to use a cell phone in this manner. In order to eliminate this problem, a variety of hand-free transmitter-receiver earphone sets have been disclosed and have appeared on the market.

However, regular commercially available hand-free transmitter-receiver earphone sets have different structures. For example, a headphone type hand-free transmitter-receiver earphone set is to be fastened to the head with the speakers closely attached to the user's ears. This design of headphone type hand-free transmitter-receiver earphone set gives much pressure to the user's head, causing the user's ears to feel uncomfortable. Further, this headphone type hand-free transmitter-receiver earphone set is inconvenient to carry.

Further, there is a throat vibration activated hand-free transmitter-receiver earphone set, which, when in use, has the microphone closely attached to the user's throat to pick up vibrating signal from the user's throat and to convert received vibrating signal into sound signal. The use of this design of throat vibration activated hand-free transmitter-receiver earphone set makes the user's throat area to feel uncomfortable.

Further, in conventional hand-free transmitter-receiver earphone sets, the voice pickup, i.e., the microphone cannot be adjusted to the desired position close to the user's mouth, and surrounding noises may be received, affecting the receiving quality.

Therefore, it is desirable to provide a transmitter-receiver earphone set, which eliminates the aforesaid drawbacks.

### SUMMARY OF THE INVENTION

The present invention has been accomplished under the circumstances in view. It is therefore the main object of the present invention to provide a transmitter-receiver earphone set, which eliminates the aforesaid drawbacks. It is another object of the present invention to provide a transmitter-receiver earphone set, which is comfortable in use. It is still another object of the present invention to provide a transmitter-receiver earphone set, which enables the user to receive the receiver unit in the body of the earphone set when not in use or to extend the receiver unit out of the body of the earphone set when in use. To achieve this and other objects of the present invention, the folding earphone comprises a narrow elongated hollow body, a receiver unit, and a button. The body comprises a protruding transmitter unit at one end thereof. The transmitter unit has a speaker and a cable extending from the speaker toward the inside of the transmitter unit for connection to an external electronic apparatus, a narrow elongated groove extending outwards from a bottom side of the transmitter unit and terminating at a pivot end. The receiver unit is receivable in the narrow elongated groove of the body, having a free end mounted with a microphone, a lock hole formed in the free end, a fixed end pivotally coupled to the pivot end of the body for enabling the receiver unit to be turned relative to the body between a received non-operative position where the free end is received inside the narrow elongated groove and an extended operative position where the free end is moved out of the narrow elongated groove, and a release control mechanism installed in the fixed end and adapted to turn the receiver unit from the received non-operative position to the extended operative position. The button is installed in the body adjacent to the transmitter unit and adapted to lock the receiver unit in the received non-operative position, comprising a locking rod for engaging the lock hole of the receiver unit to lock the receiver unit in the received non-operative position.

The above and other objects, features and advantages of the present invention will become apparent from the following detailed description taken with the accompanying drawings.

### BRIEF DESCRIPTION OF THE DRAWINGS

FIG. 1 is an exploded view of a folding earphone according to the present invention.

FIG. 2 is a schematic drawing of the present invention, showing the receiver unit turned in and out of the body between the received non-operative position and the extended operative position.

### DETAILED DESCRIPTION OF THE PREFERRED EMBODIMENTS

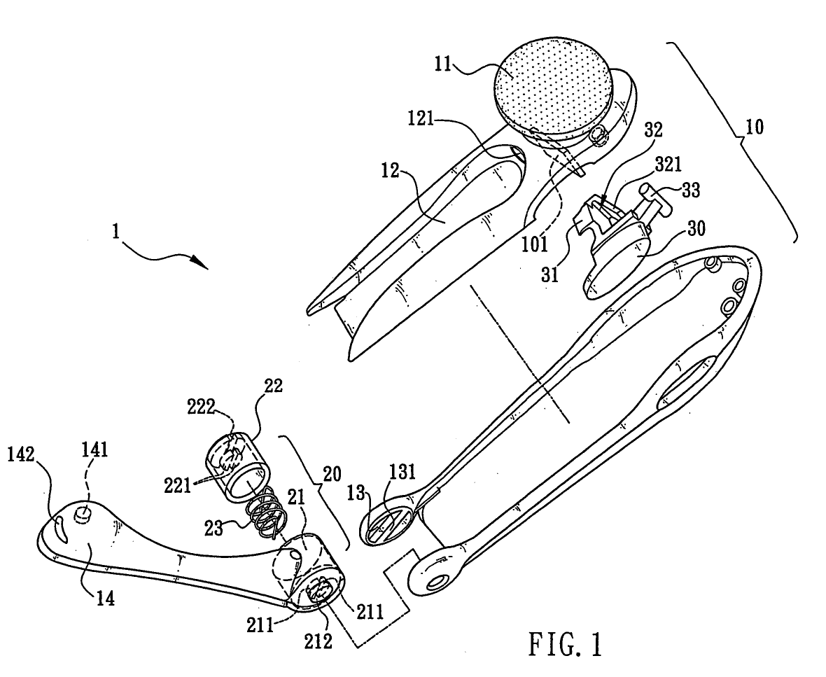

Referring to FIG. 1, a folding earphone 1 in accordance with the present invention is shown comprising a narrow elongated body 10. The body 10 is a hollow device having a protruding transmitter unit 11 at one end. The transmitter unit 11 has a speaker (not shown) on the inside and a cable (not shown) extending from the speaker toward the inside of the transmitter unit 11 for connection to an external electronic apparatus (not shown (for example, cell phone, computer)) for voice output of the external electronic apparatus through the transmitter unit 11.

The narrow elongated body 10 comprises a narrow elongated groove 12 extending outwards from the bottom side of the transmitter unit 11. The outer end of the narrow elongated groove 12 is a pivot end having two pivot holes 13 axially aligned at two sides and a rib 131 in one of the two pivot holes 13.

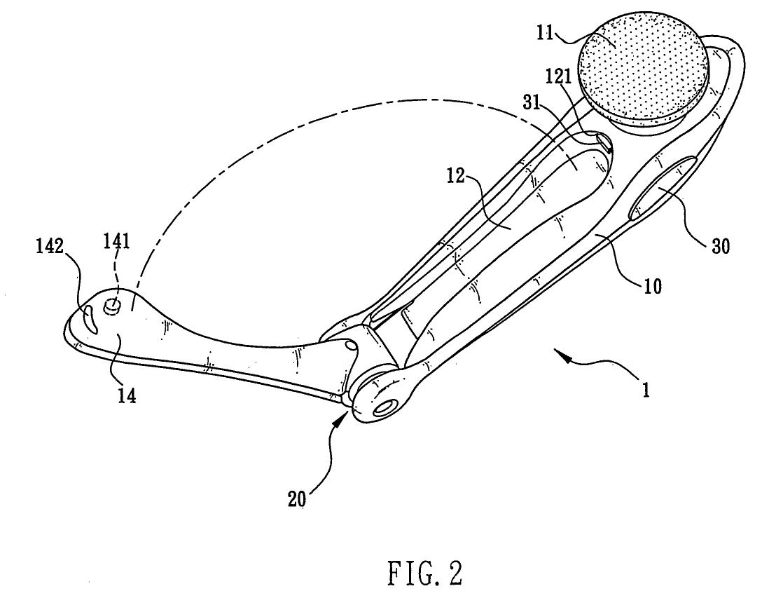

Referring to FIG. 1 again, the narrow elongated groove 12 of the narrow elongated body 10 accommodates a receiver unit 14. The receiver unit 14 has one end, namely, the first end internally mounted with a microphone 141 for receiving voices of the user. The other end, namely, the second end of the receiver unit 14 is a pivot end pivotally connected to the pivot end at the outer end of the narrow elongated groove 12 of the narrow elongated body 10 (i.e., pivotally coupled between the pivot holes 13). A release control mechanism 20 is installed in the pivot end of the receiver unit 14 for enabling the receiver unit 14 to be turned about the axis passing through the pivot holes 13 and received in the narrow elongated groove 12 of the narrow elongated body 10 or ejected out of the narrow elongated groove 12 of the narrow elongated body 10 slowly (see also FIG. 2).

Referring to FIGS. 1 and 2 again, the narrow elongated body 10 has a button 30 disposed adjacent to the transmitter unit 11. The button 30 has a locking rod 31 inserted into a lock hole 142 in one end of the receiver unit 14. When pressed the button 30, the locking rod 31 is disengaged from the lock hole 142 to release the release control mechanism 20, thereby causing the release control mechanism 20 to turn the receiver unit 14 out of the narrow elongated groove 12 of the narrow elongated body 10 slowly (see FIG. 2).

Referring to FIG. 1 again, the release control mechanism 20 comprises a receiving open chamber 21 formed in the second end of the receiver unit 14 and facing toward the pivot hole 13 with the rib 131, a pivot rod 212 projecting from the second end of the receiver unit 14 opposite to the receiving open chamber 21 and pivotally coupled to the pivot hole 13 without rib, a first spring holder member 211 disposed on the inside of the receiving open chamber 21, a socket 22 inserted into the receiving open chamber 21, a second spring holder member 221 disposed on the inside of the socket 22 and aimed at the first spring holder member 211, a spring member 23 connected between the first spring holder member 211 in the receiving open chamber 21 and the second spring holder member 221 in the socket 22, and a coupling groove 222 formed in the bottom side of the socket 22 and coupled to the pivot hole 13 with the rib 131. Immediately after disengagement of the lock hole 142 of the receiver unit 14 from the locking rod 31 of the button 30, the spring member 23 releases the preserved torsional spring force to turn the receiver unit 14 about the axis of the pivot holes 13 in outward direction from the narrow elongated groove 12 of the narrow elongated body 10 (see FIG. 2).

Further, Vaseline (petrolatum) is applied to the inside wall of the receiving open chamber 21 and the outside wall of the socket 22 to enhance friction force between the receiving open chamber 21 and the outside wall of the socket 22, smoothening turning motion of the receiver unit 14 relative to the narrow elongated body 10 and preventing escape of the spring member 23 out of the receiving open chamber 21 and the socket 22.

Referring to FIG. 1 again, the button 30 has a V-shaped spring arm 32, which has one side formed integral with one end of the locking rod 31 and the other side 321 stopped against a stop wall 101 in the narrow elongated body 10, and a pivot rod 33 extending from one end of the top side thereof and pivotally coupled to the inside of the narrow elongated body 10. Therefore, pressing the button 30 causes the button 30 to be turned with the pivot rod 33 relative to the narrow elongated body 10 to further force the side 321 against the stop wall 101 and release the locking rod 31 from the lock hole 142, for enabling the spring member 23 to turn the receiver unit 14 out of the narrow elongated groove 12 of the narrow elongated body 10.

As indicated above, the receiver unit 14 is received in the narrow elongated groove 12 of the narrow elongated body 10 when not in use. When the user wishes to use the receiver unit 14, press the button 30 to disengage the locking rod 31 from the lock hole 142, for enabling the spring member 23 to turn the receiver unit 14 out of the narrow elongated groove 12 of the narrow elongated body 10 from the received non-operative position to the extended operative position. On the contrary, the user can turn the receiver unit 14 from the extended operative position to the received non-operative position, enabling the lock hole 142 to be forced into engagement with the locking rod 31 to lock the receiver unit 14.

A prototype of folding earphone has been constructed with the features of FIGS. 1 and 2. The folding earphone functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A transmitter-receiver earphone set e comprising:
a narrow elongated hollow body, said body comprising a protruding transmitter unit at one end thereof, said transmitter unit having a speaker and a cable extending from said speaker toward the inside of said transmitter unit for connection to an external electronic apparatus, a narrow elongated groove extending outwards from a bottom side of said transmitter unit and terminating at a pivot end;
a receiver unit receivable in said narrow elongated groove of said body, said receiver unit having a free end mounted with a microphone, a lock hole formed in said free end, a fixed end pivotally coupled to the pivot end of said body for enabling said receiver unit to be turned relative to said body between a received non-operative position where said free end is received inside said narrow elongated groove and an extended operative position where said free end is moved out of said narrow elongated groove, and a release control mechanism installed in said fixed end and adapted to turn said receiver unit from said received non-operative position to said extended operative position;
a button installed in said body adjacent to said transmitter unit and adapted to lock said receiver unit in said received non-operative position, said button comprising a locking rod for engaging the lock hole of said receiver unit to lock said receiver unit in said received non-operative position.

2. The transmitter-receiver earphone set as claimed in claim 1, wherein the pivot end of said body comprises a first pivot hole and a second pivot hole axially aligned at two sides, and a rib in said first pivot hole.

3. The transmitter-receiver earphone set as claimed in claim 2, wherein said release control mechanism comprises a receiving open chamber formed in the fixed end of said receiver unit and facing toward said first pivot hole, a pivot rod projecting from the fixed end of said receiver unit opposite to said receiving open chamber and pivotally coupled to said second pivot hole, a first spring holder member disposed inside said receiving open chamber, a socket inserted into said receiving open chamber, a second spring holder member disposed inside said socket and aimed at said first spring holder member, a spring member connected between said first spring holder member in said receiving open chamber and said second spring holder member in said socket, and a coupling groove formed in a bottom side of said socket and coupled to said second pivot hole and said rib.

4. The transmitter-receiver earphone set as claimed in claim 3, wherein the contact area between said receiving open chamber and said socket is covered with a layer of Vaseline (petrolatum).

5. The transmitter-receiver earphone set as claimed in claim 1, wherein said button has a V-shaped spring arm, which has a first side formed integral with one end of said locking rod and a second side stopped against a stop wall in said body, and a pivot rod extending from one end of a top side thereof and pivotally coupled to a part inside said body.
